(19) United States
(12) Patent Application Publication
(10) Pub. No.: US 2026/0079658 A1
(43) Pub. Date: Mar. 19, 2026

(54) PRINTING SYSTEM CAPABLE OF SETTING UP SCHEDULE FOR PRINT JOBS

(71) Applicant: KYOCERA Document Solutions Inc., Osaka (JP)

(72) Inventor: Naoki SEKIOKA, Osaka (JP)

(73) Assignee: KYOCERA Document Solutions Inc., Osaka (JP)

(21) Appl. No.: 19/326,828

(22) Filed: Sep. 12, 2025

(30) Foreign Application Priority Data
Sep. 17, 2024 (JP) 2024-160396

(51) Int. Cl. G06F 3/12

(52) U.S. Cl. CPC G06F 3/1263; G06F 3/1205; G06F 3/1275; G06F 3/1296

(57) ABSTRACT

In a printing system, a controller sets a schedule containing a scheduled start date and time and a deadline for completion of a first print job both input by a user, and sets a period from the scheduled start date and time to a final printing acceptable time point of a first print job a time required for execution earlier than the deadline for completion as a printing start permission period for the first print job. The controller determines whether if an interrupt print job is set up and started, the interrupt print job ends before or within the printing start permission period for the first print job. When the interrupt print job ends before or within the printing start permission period, the controller maintains the schedule. When the interrupt print job ends after the printing start permission period, the controller allows a display device to display a warning screen.

### INCORPORATION BY REFERENCE

This application claims priority to Japanese Patent Application No. 2024-160396 filed on Sep. 17, 2024, the entire contents of which are incorporated by reference herein.

### BACKGROUND

The present disclosure relates to printing systems that send a print job from an image generating device to an image forming apparatus and execute the print job on the image forming apparatus, and particularly relates to a technique for setting up a schedule for print jobs on the image generating device.

Among printing systems, there is one which includes an image generating device and an image forming apparatus and in which the image generating device sends a print job to the image forming apparatus and the image forming apparatus prints an image of the sent print job.

For example, an image formation system is known in which an image forming apparatus includes a printing device, a first back-end communication device, a second back-end communication device, and a query management device. When it is determined that sending of an accept response is possible, the query management device of the image forming apparatus sends an accept response through the first back-end communication device to a digital front-end (corresponding to an image generating device). The second back-end communication device receives print data from the digital front-end. When the second back-end communication device receives print data from the digital front-end, the printing device executes print processing based on the print data. Thus, the image forming apparatus can stably and rapidly execute the processing of receiving print data from the digital front-end without being influenced by other data communications.

### SUMMARY

A technique improved over the aforementioned techniques is proposed as one aspect of the present disclosure.

A printing system according to an aspect of the present disclosure includes an image generating device and an image forming apparatus that performs data communication with the image generating device. The image generating device includes a first communication device, an operation device, and a first control device. The first communication device performs data communication with the image forming apparatus. The operation device accepts an input of an instruction from a user. The first control device includes a processor and functions as a first controller through the processor executing a control program. The first controller sets, as a schedule, a scheduled start date and time and a deadline for completion of the first print job both input by an operation on the operation device, determines a time required for execution of the first print job until completion of the execution of the first print job, sets a period from the scheduled start date and time of the first print job to a final printing acceptable time point the time required for execution earlier than the deadline for completion of the first print job as a printing start permission period for the first print job within which the first print job is completable by the deadline for completion, and allows the first communication device to send the first print job to the image forming apparatus at the scheduled start date and time of the first print job in the schedule. When an interrupt print job is input by an operation on the operation device, the first controller determines a time required for execution of the interrupt print job until completion of the execution of the interrupt print job and determines whether or not if the interrupt print job is immediately started, an end of the time required for execution of the interrupt print job is later than the final printing acceptable time point of the first print job. When determining that the end of the time required for execution of the interrupt print job is not later than the final printing acceptable time point of the first print job, the first controller maintains the schedule, allows the first communication device to send the interrupt print job to the image forming apparatus, and then allows the first communication device to send the first print job to the image forming apparatus within the printing start permission period for the first print job. When determining that the end of the time required for execution of the interrupt print job is later than the final printing acceptable time point of the first print job, the first controller keeps from accepting setting-up of the interrupt print job. The image forming apparatus includes a second communication device, an image forming device, and a second control device. The second communication device performs data communication with the image generating device. The image forming device forms an image on a recording paper sheet. The second control device includes a processor and functions as a second controller through the processor executing a control program. When the first print job is received by the second communication device, the second controller allows the image forming device to form an image based on the first print job. When the interrupt print job is received by the second communication device, the second controller allows the image forming device to form an image based on the interrupt print job.

### BRIEF DESCRIPTION OF THE DRAWINGS

FIG. 1 is a block diagram showing a printing system according to one embodiment of the present disclosure and the respective configurations of an image generating device and an image forming apparatus in the printing system.

FIG. 2 is a table showing an example of a conventional schedule.

FIG. 3A is a table showing a schedule according to an embodiment of the present disclosure.

FIG. 3B is a timing chart showing first to third print jobs to be executed in accordance with the schedule according to the embodiment.

FIG. 4 is a timing chart showing the first to third print jobs when the schedule is maintained even though an interrupt print job has been set up after the preparation of the schedule according to the embodiment.

FIGS. 5A, 5B, and 5C are timing charts showing the first to third print jobs when the schedule is changed by postponement because an interrupt print job has been set up after the preparation of the schedule according to the embodiment.

FIG. 6 is a flowchart showing a control procedure for setting up a schedule on the image generating device according to the embodiment.

FIG. 7 is a view showing a scheduling screen displayed on a display device of the image generating device.

FIG. 8 is a view showing a warning screen displayed on the display device of the image generating device.

FIG. 9 is a sequence chart showing a communication protocol established between the image generating device and the image forming apparatus.

FIG. 10 is a flowchart showing a control procedure of the image generating device when an interrupt print job arrives during execution of a print job set up in the schedule according to the embodiment.

### DETAILED DESCRIPTION

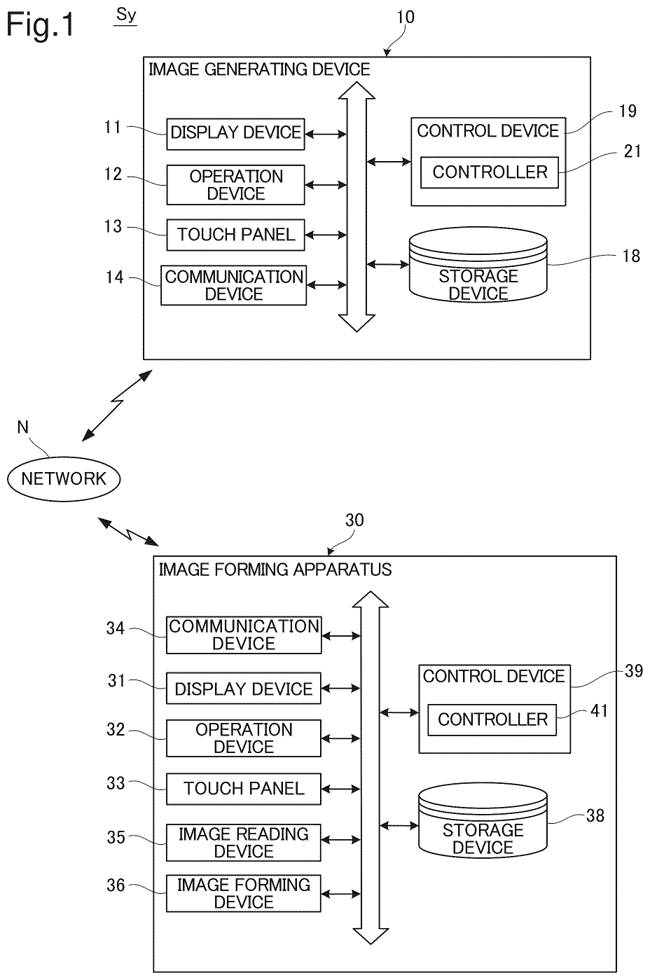

Hereinafter, a description will be given of a printing system according to an embodiment as an aspect of the present disclosure with reference to the drawings. FIG. 1 is a block diagram showing a printing system according to one embodiment of the present disclosure and the respective configurations of an image generating device and an image forming apparatus in the printing system. In a printing system Sy according to this embodiment, an image generating device 10 and an image forming apparatus 30 are connected to each other via a network N.

In this printing system Sy, the image generating device 10 is an example of a digital front-end, for example, a server or a personal computer, is connected via the network N to the image forming apparatus 30, and performs data communication with the image forming apparatus 30.

The image generating device 10 includes a display device 11, an operation device 12, a touch panel 13, a communication device 14, a storage device 18, a control device 19, and so on, wherein these components perform data or signal transfer via a bus among them.

The display device 11 is formed of a liquid crystal display (LCD), an organic EL (organic light-emitting diode (OLED)) display or the like.

The touch panel 13 is disposed over the screen of the display device 11. The touch panel 13 detects a touch on the touch panel 13 with a user's finger or the like, together with a point of the touch, and outputs a detection signal indicating the coordinate of the point of touch to a controller 21 of the control device 19. Thus, through the touch panel 13, a GUI (graphical user interface) or the like being displayed on the screen of the display device 11 can be operated. Therefore, the touch panel 13 functions as an operation device through which a user's operation on the screen of the display device 11 is to be input.

The operation device 12 includes hardware keys, including numeric keys, a decision key, and a start key. The operation device 12 accepts various instructions input from a user in response to user's operations on the keys.

The communication device 14 is a communication interface including a communication module, such as a LAN chip. The communication device 14 is connected via the network (such as an intranet) N to the image forming apparatus 30 and performs data communication with the image forming apparatus 30.

The storage device 18 is a large storage device, such as an SSD (solid state drive) or an HDD (hard disk drive), and holds programs and various types of data.

The control device 19 is made up of a processor, a RAM (random access memory), a ROM (read only memory), and so on. The processor is, for example, a CPU (central processing unit), an ASIC (application specific integrated circuit) or an MPU (micro processing unit). When a program stored in the above-described ROM or the storage device 18 is executed by the above processor, the control device 19 functions as a controller 21.

The control device 19 governs the overall control of the image generating device 10. In addition, the control device 19 is connected to the display device 11, the operation device 12, the touch panel 13, the communication device 14, the storage device 18, and so on and performs operation control on each of these components and signal or data transfer to and from each of the components.

The controller 21 serves as a processor that executes various types of processing. The controller 21 also has the function of controlling the display device 11 and the communication device 14.

In the printing system Sy, the image forming apparatus 30 is, for example, an MFP (multifunction peripheral) combining a plurality of functions, such as a copy function and a scan function. The image forming apparatus 30 includes a display device 31, an operation device 32, a touch panel 33, a communication device 34, an image reading device 35, an image forming device 36, a storage device 38, and a control device 39. These components perform data or signal transfer via a bus among them.

The display device 31 is formed of a liquid crystal display, an organic EL display or the like.

The touch panel 33 is disposed over the screen of the display device 31. The touch panel 33 detects a touch on the touch panel 33 with a user's finger or the like, together with a point of the touch, and outputs a detection signal indicating the coordinate of the point of touch to a controller 41 of the control device 39. Thus, through the touch panel 33, a GUI or the like being displayed on the screen of the display device 31 can be operated.

The operation device 32 includes hardware keys, including numeric keys, a decision key, and a start key.

The image reading device 35 includes a scanner equipped with an image pickup device capable of optically reading an image of an original document and generates image data representing the image of the original document.

The image forming device 36 includes: a photosensitive drum; a charging device that uniformly charges the surface of a photosensitive drum; an exposure device that exposes the surface of the photosensitive drum to light to form an electrostatic latent image on the surface of the photosensitive drum; a developing device that develops the electrostatic latent image on the surface of the photosensitive drum into a toner image; a transfer device that transfers the toner image (an image) on the surface of the photosensitive drum to a recording paper sheet; and so on and prints an image represented by the image data on the recording paper sheet.

The communication device 34 is a communication interface including a communication module, such as a LAN chip. The communication device 34 is connected via the network (such as an intranet) N to the image generating device 10 and performs data communication with the image generating device 10.

The storage device 38 is a large storage device, such as an SSD or an HDD, and holds various types of application programs and various types of data.

The control device 39 is made up of a processor, a RAM, a ROM, and so on. When a control program stored in the above-described ROM or the storage device 38 is executed by the above processor, the control device 39 functions as a controller 41.

The controller 41 governs the overall control of the image forming apparatus 30. The control device 39 is connected to the display device 31, the operation device 32, the touch panel 33, the communication device 34, the image reading device 35, the image forming device 36, and the storage device 38. The controller 41 performs control on each of the above components and signal or data transfer to and from each of the components.

The controller 41 serves as a processor that executes various types of processing. The controller 41 also has the function of controlling the display device 31, the communication device 34, the image reading device 35, and the image forming device 36.

The communication device 14 corresponds to the first communication device defined in CLAIMS and the display device 11 corresponds to the display device defined in CLAIMS. The GUI displayed on the touch panel 13 and the screen of the display device 11 corresponds to the operation device defined in CLAIMS. The controller 21 corresponds to the first controller defined in CLAIMS. The communication device 34 corresponds to the second communication device defined in CLAIMS and the image forming device 36 corresponds to the image forming device defined in CLAIMS. The controller 41 corresponds to the second controller defined in CLAIMS.

When, in the image generating device 10, a print job containing image data representing at least one image is generated or a print job sent from another terminal device is received via the network N by the communication device 14, the controller 21 allows the storage device 18 to store the print job, reads the print job from the storage device 18, and allows the communication device 14 to send the read print job via the network N to the image forming apparatus 30.

When the print job is received by the communication device 34 of the image forming apparatus 30, the controller 41 of the image forming apparatus 30 executes the print job, specifically, allows the image forming device 36 to input the image data of the print job, and allows the image forming device 36 to form an image represented by the image data on a recording paper sheet.

In this manner, a print job is set up on the image generating device 10, sent from the image generating device 10 to the image forming apparatus 30, and executed on the image forming apparatus 30 and, thus, the image of the print job is formed on a recording paper sheet.

Furthermore, in the image generating device 10, the operation device 12 accepts an input of an instruction to prepare a schedule for a plurality of print jobs in accordance with a user's operation on the operation device 12.

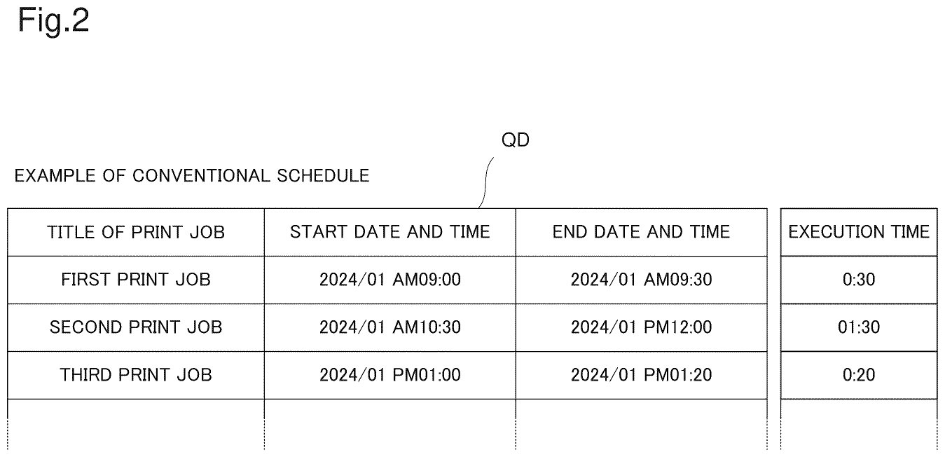

Here, a description will be given of an example of a schedule QD not according to this embodiment. FIG. 2 shows an example of a schedule QD not according to this embodiment. In the schedule QD shown in FIG. 2, as to a plurality of print jobs, the title of each print job, the start date and time of the print job, and the end date and time of the print job are set in association with each other.

For each print job to be set up, a controller of an image generating device accepts a specified start date and time of the print job and calculates the time required for execution of the print job until the completion of the execution of the print job based on the number of sheets to be printed in the print job and/or like information. Furthermore, the controller adds the time required for execution to the start date and time of the print job to calculate the end date and time of the print job and associates the respective print jobs with their respective start dates and times and their respective end dates and times in the schedule QD.

By referring to the schedule QD, every time the start date and time of each of the individual print jobs comes, the controller of the image generating device sequentially selects the appropriate print job and allows a communication device to send the print job to an image forming apparatus.

The individual print jobs are sequentially received by a communication device of the image forming apparatus at their respective start dates and times and a controller of the image forming apparatus allows the image forming device to sequentially print image data of the individual print jobs and end the print jobs at their respective end dates and times.

However, when an interrupt print job arrives while the start times of the individual print jobs have already been set in the schedule QD, the controller of the image generating device sends the interrupt print job to the image forming apparatus ahead of sending of the other print jobs and postpones all the start times of the other print jobs in the schedule QD without any consideration. Therefore, when a long time is required to end the interrupt print job, the start times of the other print jobs in the schedule QD are largely delayed.

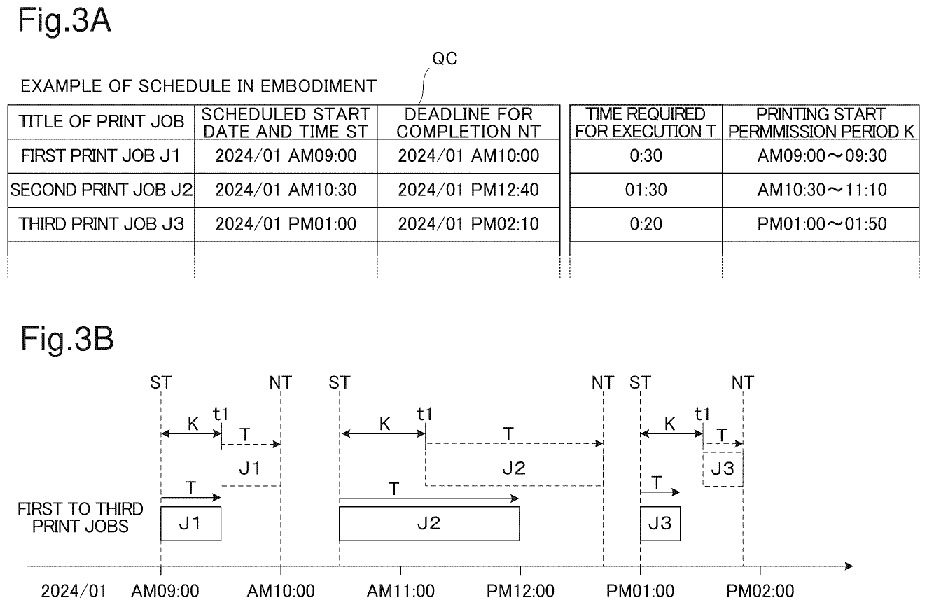

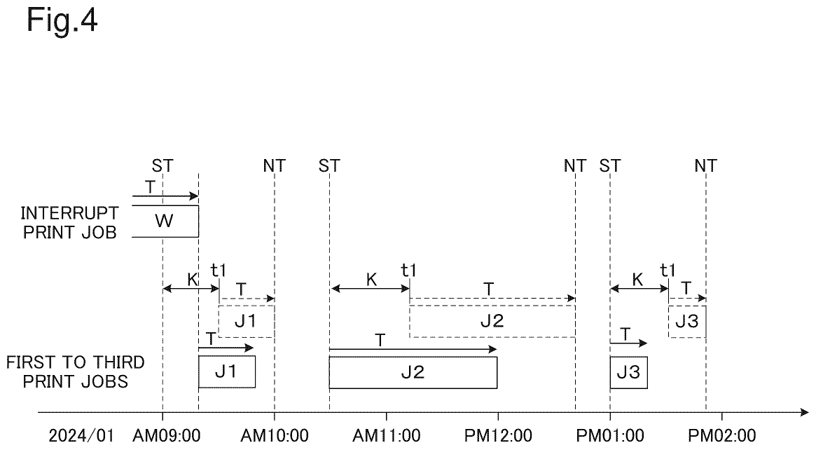

To cope with this, the controller 21 of the image generating device 10 according to this embodiment prepares, based on an instruction input to the operation device 12 by a user's operation, a schedule QC in which, for example, as shown in FIG. 3A, first to third print jobs J1 to J3, the respective scheduled start dates and times ST of the first to third print jobs J1 to J3, and the respective deadlines for completion NT of the first to third print jobs J1 to J3 are associated.

Specifically, based on the above instruction, the controller 21 of the image generating device 10 accepts the print jobs, their scheduled start dates and times, and their deadlines for completion, arranges the print jobs in order of their scheduled start date and time ST in a schedule QC, and associates the individual print jobs with their respective scheduled start dates and times ST and their respective deadlines for completion NT in the schedule QC. The print jobs arranged in order of their scheduled start date and time are referred to as a first print job J1, a second print job J2, and a third print job J3 in this order.

In addition, the controller 21 of the image generating device 10 calculates, for each of the first to third print jobs J1 to J3, the time required for execution T until the completion of execution of the print job based on the number of sheets having images to be printed in the print job and/or like information, and sets a period from the scheduled start date and time ST of the print job to a final printing acceptable time point thereof as a printing start permission period K for the print job within which the print job started within the period is completable by the deadline for completion NT. The final printing acceptable time point is a time point the time required for execution T earlier than the deadline for completion (a delivery date and time) NT.

In this manner, as shown in the timing chart of FIG. 3B, for each of the first to third print jobs J1 to J3, the scheduled start date and time ST of the print job, the deadline for completion NT thereof, and the printing start permission period K therefor are set by the controller 21. In either print job, the printing start permission period K is a period from the scheduled start date and time ST to a time point t1 the time required for execution T earlier than the deadline for completion NT. Therefore, when the print job is started within the printing start permission period K, it can be completed by the deadline for completion NT.

The controller 21 of the image generating device 10 allows the storage device 18 to store the first to third print jobs J1 to J3 and allows, for example, a built-in timer to measure the current date and time. When the measured current date and time reaches the scheduled start date and time ST of the first print job J1 in the schedule QC, the controller 21 reads the first print job J1 from the storage device 18 and allows the communication device 14 to send the read first print job J1 via the network N to the image forming apparatus 30.

When the first print job J1 is received by the communication device 34 of the image forming apparatus 30, the controller 41 of the image forming apparatus 30 allows the image forming device 36 to form images represented by image data of the first print job J1 on recording paper sheets.

Also as for each of the second and third print jobs J2 and J3, like the first print job J1, when the current date and time reaches the scheduled start date and time ST of the print job, the controller 21 reads the appropriate print job from the storage device 18 and allows the communication device 14 to send the read print job to the image forming apparatus 30 and the print job is executed on the image forming apparatus 30.

In this case, as for all the first to third print jobs J1 to J3, the print job is started within the printing start permission period K and, therefore, the print job is completed by its deadline for completion NT.

Next, a description will be given of the case where after the schedule QC shown in FIG. 3A has been prepared, an interrupt print job W to be executed ahead of the first print job J1 in the schedule QC is set up on the image generating device 10.

In setting up an interrupt print job W, the controller 21 of the image generating device 10 determines the time required for execution T of the interrupt print job W and determines whether or not if the interrupt print job W is set up and immediately started, the time point of passage of the time required for execution T of the interrupt print job W is beyond the printing start permission period K for the first print job J1 (i.e., whether or not it is later than the final printing acceptable time point of the first print job J1).

When the end of the time required for execution T of the interrupt print job W is not beyond the printing start permission period K for the first print job J1, the first print job J1 can be completed by (not later than) the deadline for completion NT thereof as long as the first print job J1 is started within the printing start permission period K after the end of the interrupt print job W. Therefore, when determining that the end of the time required for execution T of the interrupt print job W is not beyond the printing start permission period K for the first print job J1, the controller 21 enables the interruption of the interrupt print job W and maintains the schedule QC.

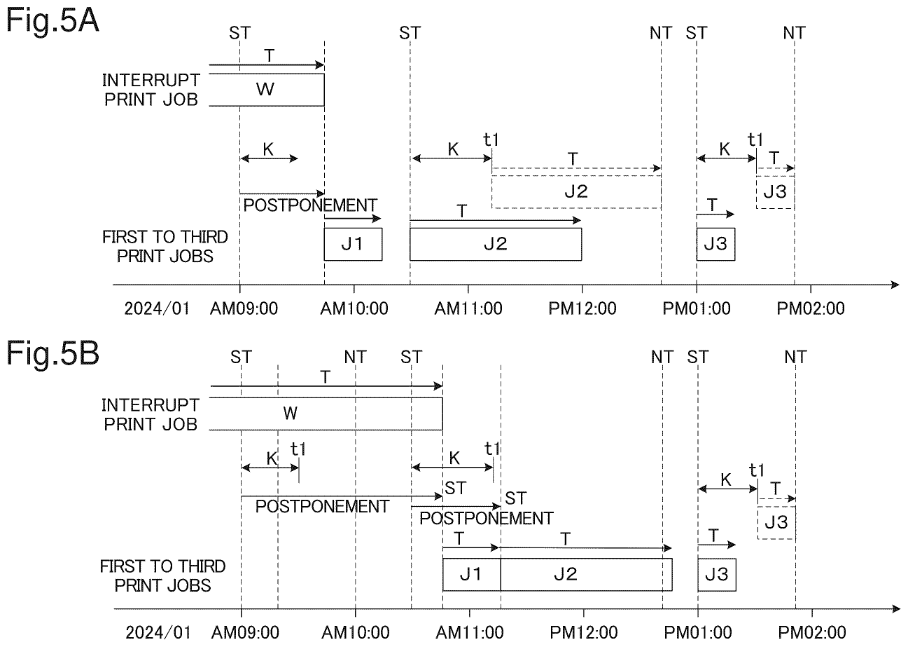

In this case, as shown in the timing chart of FIG. 4, the interrupt print job W is completed within the printing start permission period K for the first print job J1, the first print job J1 is started within the printing start permission period K after the end of the interrupt print job W, the first print job J1 is completed by its deadline for completion NT, and the second and third print jobs J2, J3 are started at their respective scheduled start dates and times ST.

The controller 21 of the image generating device 10 allows the communication device 14 to send the interrupt print job W via the network N to the image forming apparatus 30, subsequently reads the first print job J1 from the storage device 18, and allows the communication device 14 to send the read first print job J1 via the network N to the image forming apparatus 30.

When the interrupt print job W is received by the communication device 34 of the image forming apparatus 30, the controller 41 of the image forming apparatus 30 starts executing the interrupt print job W. When the first print job J1 is subsequently received by the communication device 34, the controller 41 executes the first print job J1 immediately after the completion of the interrupt print job W.

On the other hand, when determining that the end of the time required for execution T of the interrupt print job W is beyond the printing start permission period K for the first print job J1, (i) the controller 21 of the image generating device 10 keeps from setting up the interrupt print job, because the first print job J1 is not started until after the final printing acceptable time point.

Alternatively, when determining that the end of the time required for execution T of the interrupt print job W is beyond the printing start permission period K for the first print job J1, (ii) the controller 21 of the image generating device 10 allows the display device 11 to display on the screen thereof a message indicating that the completion of the first print job J1 is later than the deadline for completion NT and prompting to input an instruction to execute or not to execute the interrupt print job W. In accordance with an instruction input to the operation device 12 by a user's operation, the controller 21 either (a) cancels the interrupt print job W and leaves the schedule QC unchanged or (b) sets up the interrupt print job W and changes the schedule QC.

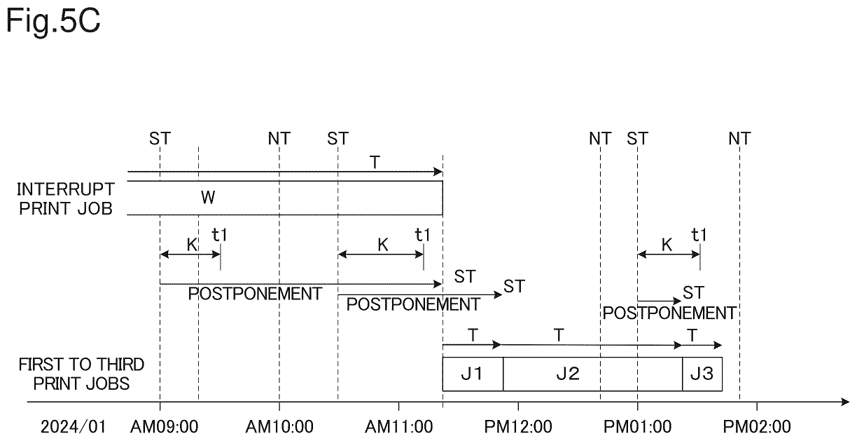

For example, as in the timing charts shown in FIGS. 5A, 5B, and 5C, there may be cases where the completion of the interrupt print job W is later than the printing start permission period K for the first print job J1. In these cases, the controller 21 changes the scheduled start date and time ST of the first print job J1 by postponing it until the end of the time required for execution T of the interrupt print job W (see FIG. 5A).

As for the second print job J2, when the time point of completion of the first print job J1 (the end time point of the time required for execution T thereof) after the scheduled start date and time ST of the first print job J1 has been changed in the above manner is later than (beyond) the scheduled start date and time ST of the second print job J2, the controller 21 changes the scheduled start date and time ST of the second print job J2 by postponing it until the time point of completion of the first print job J1 (see FIG. 5B). However, when the time point of completion of the first print job J1 after the scheduled start date and time ST thereof has been changed is not later than the scheduled start date and time ST of the second print job J2, the controller 21 leaves the scheduled start date and time ST of the second print job J2 unchanged (see FIG. 5A).

Likewise, as for the third print job J3, when the time point of completion of the second print job J2 after the scheduled start date and time ST thereof has been changed is later than the scheduled start date and time ST of the third print job J3, the controller 21 changes the scheduled start date and time ST of the third print job J3 by postponing it until the end of the time required for execution T of the second print job J2 after the scheduled start date and time thereof has been changed (see FIG. 5C). However, when the time point of completion of the second print job J2 after the scheduled start date and time ST thereof has been changed is not later than the scheduled start date and time ST of the third print job J3, the controller 21 leaves the scheduled start date and time ST of the third print job J3 unchanged (see FIGS. 5A and 5B).

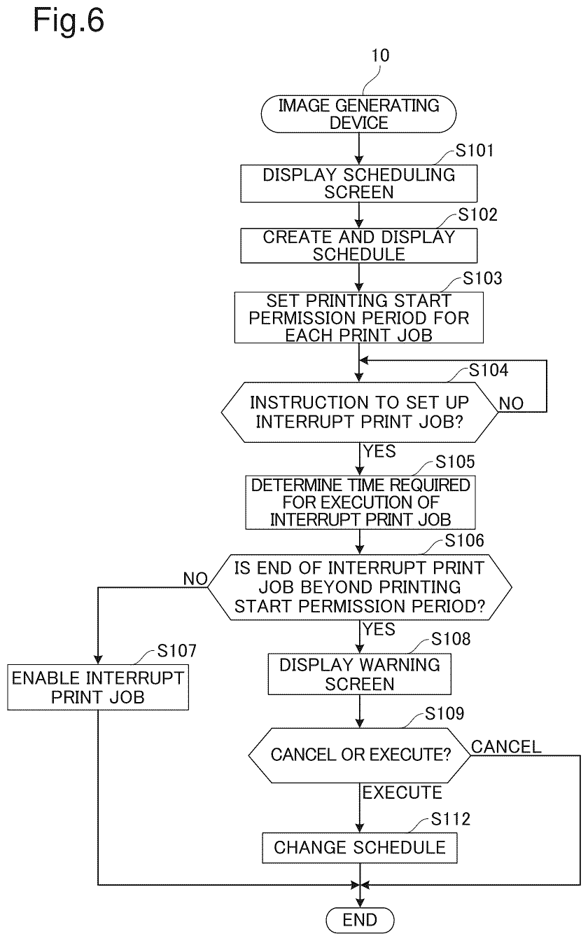

Next, a detailed description will be given of a control procedure for preparing a schedule QC and addressing an interrupt print job W in the above manner with reference to the flowchart shown in FIG. 6.

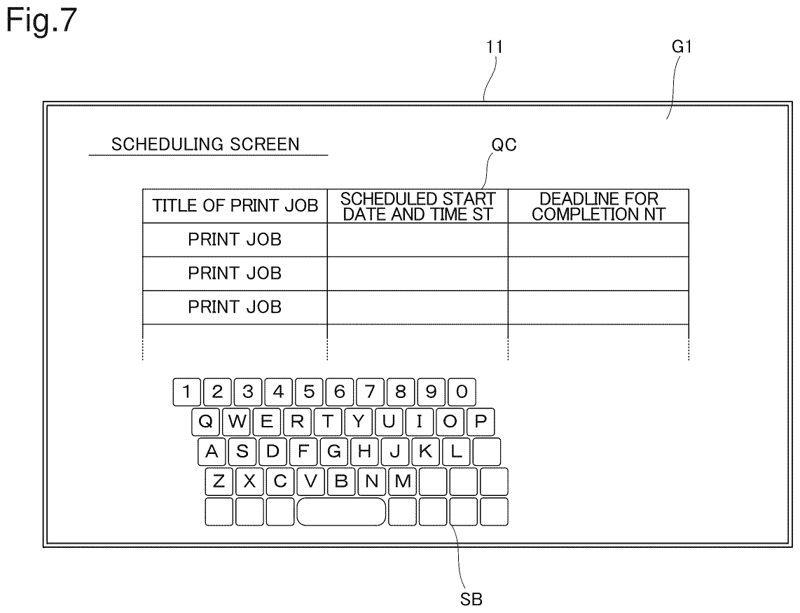

In the image generating device 10, when an instruction to start executing a scheduling function is accepted by the operation device 12 based on a user's operation, the controller 21 reads a plurality of print jobs from the storage device 18 in accordance with this instruction and allows the display device 11 to display a scheduling screen G1 shown as an example in FIG. 7 (S101).

The display on the scheduling screen G1 shown in FIG. 7 contains a schedule QC and a software keyboard SB. The schedule QC displayed on the screen contains a plurality of print jobs arranged in a row, respective entry fields for scheduled start date and time ST associated with the print jobs, and respective entry fields for deadline for completion NT associated with the print jobs.

The operation device 12 accepts, based on a user's operation on the touch panel, for example, for each print job, an instruction to select the entry field for scheduled start date and time ST based on a touch gesture on the entry field for scheduled start date and time ST, a value indicating the scheduled start date and time ST based on touch gestures on the software keyboard SB, an instruction to select the entry field for deadline for completion NT based on a touch gesture on the entry field for deadline for completion NT, or a value indicating the deadline for completion NT based on touch gestures on the software keyboard SB.

The controller 21 of the image generating device 10 detects, for each print job, the value of the scheduled start date and time ST and the value of the deadline for completion NT, both accepted by the operation device 12. The controller 21 rearranges the print jobs in order of their scheduled start date and time ST, associates each print job with its scheduled start date and time ST and its deadline for completion NT, creates a schedule QC with these contents, like the one shown in FIG. 3A, and allows the display device 11 to display the schedule QC on the screen (S102). As shown in FIG. 3A, the print jobs arranged in order of their scheduled start date and time ST in the schedule QC are referred to as a first print job J1, a second print job J2, and a third print job J3 in this order.

The controller 21 of the image generating device 10 calculates, for each of the first to third print jobs J1 to J3, the time required for execution T of the print job until the completion of the print job based on the number of sheets having images to be printed in the print job and/or like information, and sets a period from the scheduled start date and time ST of the print job to a final printing acceptable time point t1 thereof the time required for execution T earlier than the deadline for completion NT of the print job as a printing start permission period K within which the print job is completable by the deadline for completion NT (S103).

In doing so, when the printing start permission period K for the print job is not longer than a predetermined specified period, the controller 21 may allow the display device 11 to display on the screen a message prompting to revise and put off the deadline for completion NY of the print job. When viewing the message, the user can revise and put off the deadline for completion NT of the print job by touch gestures on the software keyboard SB. The controller 21 does the processing in S102 again to reprepare the schedule QC and allows the display device 11 to display the reprepared schedule QC. Thus, a situation can be avoided where because the printing start permission period K is too short, schedule rearrangement for wedging the interrupt print job W between the print jobs does not work.

In a state where the schedule QC is prepared in the above manner, the controller 21 of the image generating device 10 measures the current date and time. When, for each of the first to third print jobs J1 to J3, the current date and time reaches the scheduled start date and time ST of the print job, the controller 21 reads the print job from the storage device 18 and allows the communication device 14 to send the print job via the network N to the image forming apparatus 30.

When, for each of the first to third print jobs J1 to J3, the print job is received by the communication device 34 of the image forming apparatus 30, the controller 41 of the image forming apparatus 30 executes the print job.

After the schedule QC is prepared, the controller 21 of the image generating device 10 waits for an instruction to set up an interrupt print job W (“No” in S104). Now assume that an instruction to set up an interrupt print job W is accepted by the operation device 12 in accordance with a user's operation.

When an instruction to set up an interrupt print job W is accepted (“Yes” in S104), the controller 21 of the image generating device 10 calculates the time required for execution T of the interrupt print job W based on the number of sheets to be printed in the interrupt print job W and/or like information (S105) and determines whether or not if the interrupt print job W is set up and immediately started, the end of the time required for execution T of the interrupt print job W (the time point of completion of the job) is beyond the printing start permission period K for the first print job J1 (whether or not it is later than the final printing acceptable time point t1 of the first print job J1) (S106).

When determining that, as shown in the timing chart of FIG. 4, the end of the time required for execution T of the interrupt print job W is not beyond the printing start permission period K for the first print job J1 (“No” in S106), the controller 21 enables the interruption of the interrupt print job W (S107) and maintains the schedule QC. The reason for this is that as long as the first print job J1 is started following the end of the interrupt print job W, the first print job J1 can be completed by the deadline for completion NT thereof.

In this case, the controller 21 of the image generating device 10 allows the communication device 14 to send the interrupt print job W via the network N to the image forming apparatus 30 and then allows the communication device 14 to send the first print job J1 via the network N to the image forming apparatus 30 at a later timing, for example, at the timing when the period from the sending of the interrupt print job W to the end the time required for execution T of the interrupt print job W is over.

When the interrupt print job W is received by the communication device 34 of the image forming apparatus 30, the controller 41 of the image forming apparatus 30 executes the interrupt print job W. When the first print job J1 is subsequently received by the communication device 34, the controller 41 executes the first print job J1.

Thereafter, the controller 21 of the image generating device 10 measures the current date and time. When, for each of the second and third print jobs J2, J3, the current date and time reaches the scheduled start date and time ST of the print job, the controller 21 reads the print job from the storage device 18 and allows the communication device 14 to send the print job via the network N to the image forming apparatus 30.

When, for each of the second and third print jobs J2, J3, the print job is received by the communication device 34 of the image forming apparatus 30, the controller 41 of the image forming apparatus 30 executes the print job.

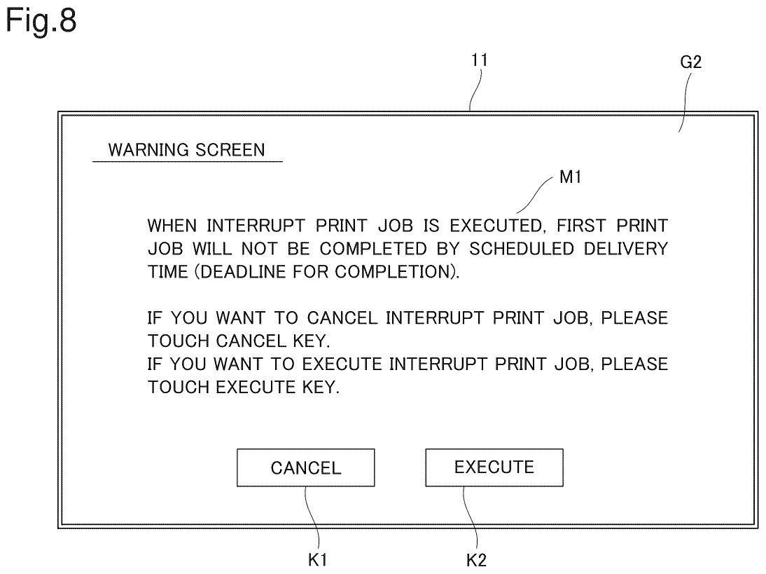

On the other hand, when determining that, as shown in the timing chart of FIG. 5A, the end of the time required for execution T of the interrupt print job W is beyond the printing start permission period K for the first print job J1 (“Yes” in S106), the controller 21 of the image generating device 10 allows the display device 11 to display a warning screen G2 (S108) as shown as an example in FIG. 8. The reason for this is that the first print job J1 is not started within the printing start permission period K therefor and the time point of completion of the first print job J1 is later than the deadline for completion NT thereof.

The display on the warning screen G2 shown in FIG. 8 contains: a warning message M1 indicating that when the interrupt print job W is executed, the first print job J1 will not be completed by its deadline for completion NT; a Cancel key K1 representing an instruction to cancel the interrupt print job W; and an Execute key K2 representing an instruction to execute the interrupt print job W. When, as shown in the timing chart of FIG. 5B, not only the time point of completion of the first print job J1 is beyond the deadline for completion NT thereof, but also the end of the time required for execution T of the first print job J1 to be started following the interrupt print job W is beyond the printing start permission period K for the second print job J2 and, thus, the time point of completion of the second print job J2 is beyond the deadline for completion NT thereof, the controller 21 also allows the display device 11 to display a warning message about the second print job J2.

For example, when viewing the message M1, the user makes a touch gesture on the Cancel key K1. The controller 21 of the image generating device 10 accepts a cancel instruction based on the gesture through the touch panel 13 and cancel the interrupt print job W (“Cancel”in S109). The controller 21 leaves the schedule QC unchanged.

On the other hand, when the user makes a touch gesture on the Execute key K2, the controller 21 of the image generating device 10 accepts an execution instruction based on the gesture through the touch panel 13 (“Execute” in S109), enables the setting-up of the interrupt print job W in accordance with the execution instruction, and adds the interrupt print job W into the schedule QC to set up the interrupt print job W (S112). The controller 21 allows the communication device 14 to send the interrupt print job W via the network N to the image forming apparatus 30.

Alternatively, at the time point when the determination in S106 is Yes, the controller 21 may keep from accepting the setting-up of the interrupt print job W as described previously.

When the interrupt print job W is received by the communication device 34 of the image forming apparatus 30, the controller 41 of the image forming apparatus 30 executes the interrupt print job W.

Since the execution of the interrupt print job W makes the first print job J1 impossible to start within its printing start permission period K, the controller 21 of the image generating device 10 changes the scheduled start date and time ST of the first print job J1 by postponing it until the end of the time required for execution T of the interrupt print job W as shown in the timing chart of FIG. 5A.

Furthermore, the controller 21 of the image generating device 10 determines whether or not the end of the time required for execution T of the first print job J1 after the scheduled start date and time ST thereof has been changed is later than the scheduled start date and time ST of the second print job J2. When the controller 21 determines that, as shown in the timing chart of FIG. 5B, the end of the time required for execution T of the first print job J1 after the scheduled start date and time ST thereof has been changed is later than the scheduled start date and time ST of the second print job J2, the controller 21 changes the scheduled start date and time ST of the second print job J2 by postponing it until the end of the time required for execution T of the first print job J1 after the scheduled start date and time ST thereof has been changed. On the other hand, when determining that the end of the time required for execution T of the first print job J1 after the scheduled start date and time ST thereof has been changed is not later than the scheduled start date and time ST of the second print job J2, the controller 21 leaves the scheduled start date and time ST of the second print job J2 unchanged.

Moreover, the controller 21 of the image generating device 10 determines whether or not the end of the time required for execution T of the second print job J2 after the scheduled start date and time ST thereof has been changed is later than the scheduled start date and time ST of the third print job J3. When the controller 21 determines that, as shown in the timing chart of FIG. 5C, the end of the time required for execution T of the second print job J2 after the scheduled start date and time ST thereof has been changed is later than the scheduled start date and time ST of the third print job J3, the controller 21 changes the scheduled start date and time ST of the third print job J3 by postponing it until the end of the time required for execution T of the second print job J2 after the scheduled start date and time ST thereof has been changed. On the other hand, when determining that the end of the time required for execution T of the second print job J2 after the scheduled start date and time ST thereof has been changed is not later than the scheduled start date and time ST of the third print job J3, the controller 21 leaves the scheduled start date and time ST of the third print job J3 unchanged (S112). Thus, the schedule QC is changed.

As thus far described, when a schedule QC is prepared in accordance with an instruction from a user and an interrupt print job W is set up, whether or not the end of the time required for execution T of the interrupt print job W is beyond the printing start permission period K for the first print job J1 (later than the final printing acceptable time point of the first print job J1) is determined, i.e., whether or not the completion of the first print job J1 is later than the deadline for completion NT thereof is determined. When the completion of the first print job J1 is not later than the deadline for completion NT thereof, the schedule QC is maintained. When the completion of the first print job J1 is later than the deadline for completion NT thereof, the determination of whether or not to execute the interrupt print job W is left to the user. In accordance with the user's determination, (a) the interrupt print job W is cancelled and the schedule QC is left unchanged or (b) the interrupt print job W is executed and the schedule QC is changed.

Unlike the above case, when the interrupt print job W arrives during execution of a print job in the schedule QC, the controller 21 of the image generating device 10 suspends the print job under execution, starts and executes the interrupt print job W, and resumes the suspended print job after the end of the interrupt print job W. Therefore, this case needs to be addressed differently from the case where, as described previously, the interrupt print job W is set up before the execution of print jobs in the schedule QC.

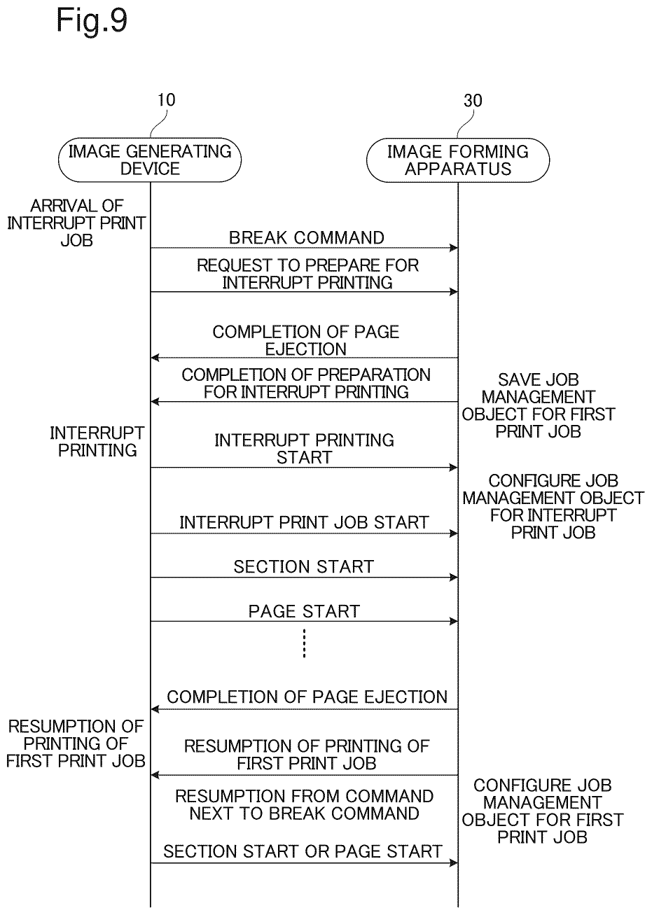

Hereinafter, a description will be given of a basic communication protocol that can be established between the image generating device 10 and the image forming apparatus 30 when an interrupt print job W arrives during execution of a print job, with reference to the sequence chart shown in FIG. 9. Now assume that an interrupt print job W arrives during execution of the first print job J1 in the schedule QC.

When an interrupt print job arrives during execution of the first print job J1, the controller 21 of the image generating device 10 allows the communication device 14 to send a break command indicating suspension of the first print job J1 and a breakpoint in the first print job J1 via the network N to the image forming apparatus 30, and subsequently allows the communication device 14 to send a request to prepare for interrupt printing via the network N to the image forming apparatus 30.

The breakpoint indicated by the break command is a page end point or a section end point. The page end point refers to an end point of any page to be printed by the execution of the first print job J1. The section end point refers to an end point of a final page of any copy when multiple copies of at least a sheet of image are printed by the execution of the first print job J1.

When the break command is received by the communication device 34 of the image forming apparatus 30 and the request to prepare for interrupt printing is subsequently received by the communication device 34, the controller 41 of the image forming apparatus 30 suspends the first print job J1 at a page end point or a section end point in the first print job J1 indicated by the break command. Thereafter, when the image forming device 36 finishes printing the image of a page located at the end point and the page at the end point is ejected, the controller 41 allows the communication device 34 to send a notification of completion of ejection of the page at the end point via the network N to the image generating device 10. Subsequently, the controller 41 allows the communication device 34 to send a notification of completion of preparation for interrupt printing via the network N to the image generating device 10 and saves a job management object for the first print job J1.

When the notification of completion of ejection of the page at the end point is received by the communication device 14 of the image generating device 10 and the notification of completion of preparation for interrupt printing is subsequently received by the communication device 14, the controller 21 of the image generating device 10 allows the communication device 14 to send a notification of start of printing of the interrupt print job W via the network N to the image forming apparatus 30 and subsequently allows the communication device 14 to send the interrupt print job W (such as a notification of job start, a notification of section start, and a notification of page start) via the network N to the image forming apparatus 30.

When the notification of start of printing of the interrupt print job W is received by the communication device 34 of the image forming apparatus 30, the controller 41 of the image forming apparatus 30 configures a job management object for the interrupt print job W. When the interrupt print job W is subsequently received by the communication device 34, the controller 41 executes the interrupt print job W to allow the image forming device 36 to form images of the interrupt print job W on recording paper sheets. Then, when the image forming device 36 finishes printing the image of the final page of the interrupt print job W and the final page is ejected, the controller 41 allows the communication device 34 to send a notification of completion of ejection of the final page via the network N to the image generating device 10.

Subsequently, the controller 41 of the image forming apparatus 30 allows the communication device 34 to send a notification of resumption of printing of the first print job J1 via the network N to the image generating device 10 and reconfigures the job management object for the first print job J1.

When the notification of completion of ejection of the final page is received by the communication device 14 of the image generating device 10 and the notification of resumption of printing of the first print job J1 is subsequently received by the communication device 14, the controller 21 of the image generating device 10 allows the communication device 14 to resume the suspended sending of the first print job J1 to send remaining unsent images of the first print job J1 via the network N to the image forming apparatus 30.

When the remaining unsent images of the first print job J1 are received by the communication device 34 of the image forming apparatus 30, the controller 41 of the image forming apparatus 30 resumes the first print job J1 and allows the image forming device 36 to form the remaining images of the first print job J1 on recording paper sheets.

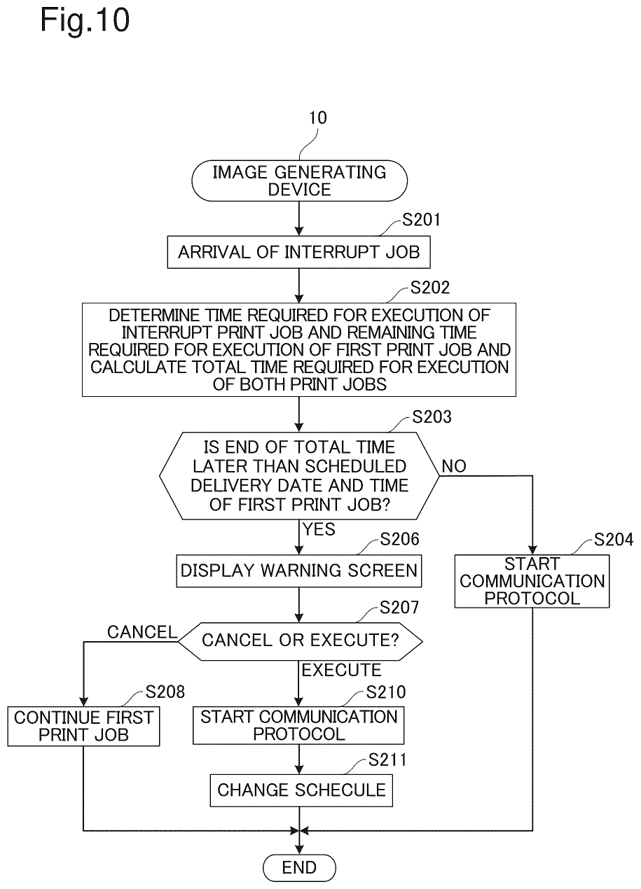

When an interrupt print job W arrives during execution of the first print job in the schedule QC, the controller 21 of the image generating device 10 executes or cancels the interrupt print job W in accordance with the control procedure of the flowchart shown in FIG. 10 and thus leaves the schedule QC unchanged or changes the schedule QC. In the control procedure of the flowchart shown in FIG. 10, the communication protocol of the sequence chart shown in FIG. 9 is established in parallel.

When an interrupt print job W arrives during execution of the first print job J1 (S201), the controller 21 of the image generating device 10 determines the time required for execution T of the interrupt print job W, determines the remaining time required for execution T of the suspended first print job J1 based on the number of remaining sheets having images to be printed in the suspended first print job J1 and/or like information, calculates the total time obtained by adding the time required for execution T of the interrupt print job W and the remaining time required for execution T of the suspended first print job J1 (S202), and determines whether or not if the interrupt print job W is started and the suspended first print job J1 is subsequently resumed, the end of the total time is later than the deadline for completion NT of the first print job J1 (S203).

When determining that the end of the total time is not later than the deadline for completion NT of the first print job J1 (“No” in S203), the controller 21 of the image generating device 10 starts the communication protocol of the sequence chart shown in FIG. 9 (S204), because the first print job J1 can be completed by its deadline for completion NT, for example, by starting the interrupt print job W and subsequently starting the suspended first print job J1. The controller 21 maintains the schedule QC.

In accordance with this communication protocol, as described above, the first print job J1 under execution on the image forming apparatus 30 is suspended, the interrupt print job W is sent from the image generating device 10 to the image forming apparatus 30, the interrupt print job W is executed on the image forming apparatus 30 to print out images of the interrupt print job W, the suspended first print job J1 is then sent from the image generating device 10 to the image forming apparatus 30 upon completion of the interrupt print job W, and the first print job J1 is resumed and executed on the image forming apparatus 30.

On the other hand, when determining that the end of the total time calculated in S202 is later than the deadline for completion NT of the first print job J1 (“Yes” in S203), the controller 21 of the image generating device 10 allows the display device 11 to display the warning screen G2 (S206) as shown in FIG. 8.

For example, when viewing the message M1, the user makes a touch gesture on the Cancel key K1. When accepting a cancel instruction through the touch panel 13 (“Cancel” in S207), the controller 21 cancels the interrupt print job W and continues the first print job J1 (S208). The controller 21 leaves the schedule QC unchanged.

When the user makes a touch gesture on the Execute key K2, the controller 21 accepts an execution instruction through the touch panel 13 (“Execute” in S207), enables the interrupt print job W, and, like S204, starts the communication protocol of the sequence chart shown in FIG. 9 (S210). In this case, the controller 21 changes the scheduled start date and time ST of the first print job J1 by postponing it until the end of the time required for execution T of the interrupt print job W, and, as for the second and third print jobs J2, J3, leaves unchanged the scheduled start date and time ST following the end of the time required for execution T of the previous print job of which the scheduled start date and time ST has been changed, or changes the scheduled start date and time ST by postponing it until the end of the time required for execution T of the previous print job of which the scheduled start date and time ST has been changed (S211).

As thus far described, when an interrupt print job W is set up during execution of the first print job J1 in the schedule QC, whether or not the completion of the first print job J1 is later than its deadline for completion NT is determined. When the completion of the first print job J1 is not later than its deadline for completion NT, the interrupt print job W is executed. When the completion of the first print job J1 is later than its deadline for completion NT, the determination of whether or not to execute the interrupt print job W is left to the user.

Although in the control procedure of the flowchart shown in FIG. 10 the interrupt print job W is executed and the first print job J1 is then resumed, the second print job J2 may be executed ahead of the remaining first print job J1 to minimize the delay of the second print job J2.

Specifically, when determining that the time point of completion of the fist print job J1 is later than the deadline for completion of the second print job J2 whereas the time point of completion of the interrupt print job W is not later than the deadline for completion of the second print job J2, the controller 21 of the image generating device 10 allows the communication device 14 to send, ahead of the remaining portion of the suspended first print job J1, the second print job J2 to the image forming apparatus 30 at the time point of completion of the interrupt print job W or later, and then allows the communication device 14 to send the remaining portion of the suspended first print job J1 to the image forming apparatus 30 at the time point of completion of the second print job J2 or later.

For example, when determining that the end of the total time calculated in S202 is later than the deadline for completion NT of the first print job J1, the controller 21 of the image generating device 10 determines whether or not the end of the total time is later than the printing start permission period K for the second print job J2. When determining that the end of the total time is later than the printing start permission period K for the second print job J2, the controller 21 allows the communication device 14 to send, ahead of the suspended first print job J1, the second print job J2 to the image forming apparatus 30 and then allows the communication device 14 to send the suspended first print job J1 to the image forming apparatus 30.

When the second print job J2 is received by the communication device 34 of the image forming apparatus 30, the controller 41 of the image forming apparatus 30 executes the second print job J2. When the suspended first print job J1 is subsequently received by the communication device 34, the controller 41 resumes and executes the first print job J1.

Although in the sequence chart shown in FIG. 9 and the flowchart shown in FIG. 10 the first print job J1 is taken as an example, the second and third print jobs J2, J3 are also dealt with, like the first print job J1, in accordance with the communication protocol shown in FIG. 9 and the control procedure shown in FIG. 10.

In a conventional printing system not according to this embodiment, its image generating device, if having the scheduling function, sets the respective printing start times of multiple print jobs and sequentially sends the individual print jobs to its image forming apparatus when their printing start times come. The image forming apparatus sequentially receives the print jobs at their printing start times and sequentially prints images of the print jobs.

However, when an interrupt print job arrives after the printing start times of the print jobs are already set, the image generating device of the above printing system not according to this embodiment sends the interrupt print job to the image forming apparatus ahead of sending of the other print jobs and postpones all the already set printing start times of the other print jobs without any consideration. Therefore, when a long time is required to end the interrupt print job, the already set printing start times of the other print jobs are largely delayed.

In the case where a digital front-end sends print data to an image forming apparatus and a printing device of the image forming apparatus executes print processing based on the print data, there is no proposed technique in which when an interrupt print job as described above arrives, the delay of already set printing start times of print jobs are eliminated.

Unlike the above conventional techniques, in the embodiment described above, it is possible to minimize the delay of the completion of already set print jobs due to the arrival of an interrupt print job.

The structure, configuration, and processing of the above embodiment described with reference to FIGS. 1 to 10 are merely illustrative of the present disclosure and are not intended to limit the present disclosure to them.

While the present disclosure has been described in detail with reference to the embodiments thereof, it would be apparent to those skilled in the art that the various changes and modifications may be made therein within the scope defined by the appended claims.

What is claimed is:

1. A printing system comprising an image generating device and an image forming apparatus that performs data communication with the image generating device, wherein
the image generating device comprises:
a first communication device that performs data communication with the image forming apparatus;
an operation device that accepts an input of an instruction from a user; and
a first control device that comprises a processor and functions, through the processor executing a control program, as a first controller that sets, as a schedule, a scheduled start date and time and a deadline for completion of the first print job both input by an operation on the operation device, determines a time required for execution of the first print job until completion of the execution of the first print job, sets a period from the scheduled start date and time of the first print job to a final printing acceptable time point the time required for execution earlier than the deadline for completion of the first print job as a printing start permission period for the first print job within which the first print job is completable by the deadline for completion, and allows the first communication device to send the first print job to the image forming apparatus at the scheduled start date and time of the first print job in the schedule,
when an interrupt print job is input by an operation on the operation device, the first controller determines a time required for execution of the interrupt print job until completion of the execution of the interrupt print job and determines whether or not if the interrupt print job is immediately started, an end of the time required for execution of the interrupt print job is later than the final printing acceptable time point,
when determining that the end of the time required for execution of the interrupt print job is not later than the final printing acceptable time point, the first controller maintains the schedule, allows the first communication device to send the interrupt print job to the image forming apparatus, and then allows the first communication device to send the first print job to the image forming apparatus within the printing start permission period for the first print job,
when determining that the end of the time required for execution of the interrupt print job is later than the final printing acceptable time point, the first controller keeps from accepting setting-up of the interrupt print job,
the image forming apparatus comprises:
a second communication device that performs data communication with the image generating device;
an image forming device that forms an image on a recording paper sheet; and
a second control device that comprises a processor and functions as a second controller through the processor executing a control program,
when the first print job is received by the second communication device, the second controller allows the image forming device to form an image based on the first print job, and
when the interrupt print job is received by the second communication device, the second controller allows the image forming device to form an image based on the interrupt print job.

2. The printing system according to claim 1,
further comprising a display device,
wherein when determining that the end of the time required for execution of the interrupt print job is later than the final printing acceptable time point, the first controller of the image generating device executes, instead of keeping from accepting setting-up of the interrupt print job, processing for setting up the interrupt print job and allows the display device to display a message indicating that the completion of the first print job is later than the deadline for completion of the first print job due to interruption of the interrupt print job.

3. The printing system according to claim 2, wherein
when the first controller of the image generating device is given an instruction to cancel the interrupt print job by an operation on the operation device while the first controller allows the display device to display the message, the first controller cancels the interrupt print job, and
when the first controller is given an instruction to execute the interrupt print job by an operation on the operation device while the first controller allows the display device to display the message, the first controller allows the first communication device to send the interrupt print job to the image forming apparatus and then allows the first communication device to send the first print job to the image forming apparatus after passage of the time required for execution of the interrupt print job from sending of the interrupt print job.

4. The printing system according to claim 2, wherein when a scheduled start date and time and a deadline for completion of a second print job to be executed after the deadline for completion of the first print job are input by an operation on the operation device and set as the schedule and, in this state, the first controller of the image generating device determines that the completion of the first print job is later than the deadline for completion of the first print job due to interruption of the interrupt print job and a time point of completion of the first print job is later than the deadline for completion of the second print job, the first controller allows the first communication device to send the second print job to the image forming apparatus at the time point of completion of the first print job or later.

5. The printing system according to claim 4, wherein when an end of the time required for execution of the first print job to be started following to the execution of the interrupt print job is later than a printing start permission period for the second print job and completion of the second print job is later than the deadline for completion of the second print job, the first controller of the image generating device allows the display device to display a warning message indicating that the completion of the second print job is later than the deadline for completion of the second print job.

6. The printing system according to claim 4, wherein when determining that the time point of completion of the first print job is later than the deadline for completion of the second print job, but a time point of completion of the interrupt print job is not later than the deadline for completion of the second print job, the first controller of the image generating device allows the first communication device to send, ahead of a remaining portion of the suspended first print job, the second print job to the image forming apparatus at the time point of completion of the interrupt print job or later, and allows the first communication device to send the remaining portion of the suspended first print job to the image forming apparatus at a time point of completion of the second print job or later.
